(19) United States
(12) Patent Application Publication
(10) Pub. No.: US 2023/0292237 A1
(43) Pub. Date: Sep. 14, 2023

(54) TECHNIQUES FOR PROCESSING TRANSMISSION BURSTS IN A DISCONTINUOUS RECEIVE CYCLE

(71) Applicant: QUALCOMM Incorporated, San Diego, CA (US)

(72) Inventors: Mickael MONDET, Louannec (FR); Peerapol TINNAKORNSRISUPHAP, San Diego, CA (US); Hyun Yong LEE, San Diego, CA (US)

(21) Appl. No.: 17/689,609

(22) Filed: Mar. 8, 2022

(51) Int. Cl. H04W 52/02

(52) U.S. Cl. CPC H04W 52/0216; H04W 88/06

(57) ABSTRACT

Aspects described herein relate to transmitting, to a network node, assistance information indicating one or more alignment parameters related to processing transmission bursts in a discontinuous receive (DRX) mode, receiving, from at least one of the network node or a second network node, a configuration of the one or more alignment parameters, and receiving, from at least one of the network node or the second network node, a transmission burst in a DRX ON duration of a DRX cycle in the DRX mode based on the one or more alignment parameters indicated by the configuration. Other aspects relate to receiving the assistance information and configuring the one or more alignment parameters.

### FIELD OF THE DISCLOSURE

Aspects of the present disclosure relate generally to wireless communication systems, and more particularly, to techniques for communicating using periodic transmission bursts.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In some wireless communication technologies, such as 5G NR, data can be transmitted to devices in transmission bursts, which can have update rates measured in hertz (Hz), such as 60 Hz, 90 Hz, 45 Hz, 120 Hz, etc. for multimedia or extended reality (XR) data. In addition, in 5G NR, a device can operate in discontinuous receive (DRX) mode where the device can reduce or terminate power to radio frequency (RF) components in certain time periods where communications are not expected to occur to conserve device power and communication resources. The DRX mode can be defined by a DRX cycle having an OFF duration where the power is reduced or terminated and an ON duration where the power is restored for wireless communications. The OFF and ON durations can be measured or defined in periods of milliseconds.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, a method for wireless communication is provided that includes transmitting, to a network node, assistance information indicating one or more alignment parameters related to processing transmission bursts in a discontinuous receive (DRX) mode, receiving, from at least one of the network node or a second network node, a configuration of the one or more alignment parameters, and receiving, from at least one of the network node or the second network node, a transmission burst in a DRX ON duration of a DRX cycle in the DRX mode based on the one or more alignment parameters indicated by the configuration.

In another aspect, a method for wireless communication is provided that includes receiving, from a user equipment (UE), assistance information indicating one or more alignment parameters related to processing transmission bursts in a DRX mode, and transmitting a configuration of the one or more alignment parameters.

In a further example, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE), in accordance with various aspects of the present disclosure;

FIG. 4 is a block diagram illustrating an example of a base station, in accordance with various aspects of the present disclosure;

FIG. 5 is a flow chart illustrating an example of a method for transmitting assistance information related to receiving transmission bursts in connected-mode discontinuous receive (CDRX) mode, in accordance with aspects described herein;

FIG. 6 illustrates an example of a timeline for a CDRX mode, in accordance with aspects described herein;

FIG. 7 is a flow chart illustrating an example of a method for configuring a device for transmitting assistance information related to receiving transmission bursts in CDRX mode, in accordance with aspects described herein; and

FIG. 8 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to processing transmission bursts while operating in a discontinuous receive (DRX) mode. In some cases, a timing of a transmission burst may not align with an ON duration of a DRX cycle. This may be due to transmission bursts being transmitted according to a periodicity defined in hertz (Hz), whereas the ON duration, or a periodicity of the ON duration, of the DRX cycle may be defined in milliseconds (e.g., as an integer number of milliseconds (ms)). For example, in extended reality (XR) multimedia transmissions, a transmission burst rate can be 60 Hz, 90 Hz, 45 Hz, 120 Hz, etc. Where the transmission burst rate is 120 Hz, transmissions may have a burst arrival periodicity, of arriving at a receiving device, at 8.333 ms (a non-integer value). In this example, a DRX ON duration every 8 ms would not properly align to receiving the transmission burst, and a non-uniform DRX cycle (e.g., 8 ms, 8 ms, 9 ms) can be used to align to the cadence of the transmission burst at 120 Hz.

Enhanced connected mode DRX (ECDRX) is proposed to extend DRX mode definitions to allow for DRX cycles to handle transmission bursts. In a first example, a two-level DRX configuration can be defined having an outer DRX cycle and an inner DRX cycle. In this example, the outer DRX cycle can define a total time of multiple DRX cycles (e.g., 25 ms for the above example), and the inner DRX cycle can define the time for each DRX cycle within the outer DRX cycle (e.g., 8 ms, 8 ms, 9 ms for the above example). For example, the outer DRX can be defined using the parameters typically used to define DRX cycles (e.g., in 5G NR and previous releases of third generation partnership project (3GPP)). The inner DRX cycle can support a number of sub-cycles, which can be non-uniform. The start of the first inner DRX cycle can be aligned to the start of the outer DRX, and the end of the last inner DRX cycle can be aligned to the end of the outer DRX, where ON duration, inactivity timer, and other DRX parameters configuration for the inner DRX cycles can be the same as that of the outer DRX cycle. The inner DRX cycle that does not conform with the other inner DRX cycles in the outer DRX cycle (e.g., the 9 ms cycle in the above example) can be referred to as the leap DRX cycle. In this first example, the DRX configuration for configuring the DRX cycle can specify the DRX outer cycle and can be extended to also specify at least the conforming DRX inner cycle (and the device receiving the configuration can determine the leap DRX cycle based on a remainder of the outer DRX cycle added to the last conforming DRX inner cycle). In another example, the DRX configuration may also be extended to define the leap DRX cycle.

In a second example, the DRX configuration for configuring the DRX cycle can specify a DRX parameter for cadence of the transmission burst (e.g., multimedia cadence that is specified/measured in Hz), and a new formula for the DRX cycle ON duration based on the cadence. In this example, DRX parameters, such as drx-ShortCadence, can be defined as a parameter that can have values in Hz, instead of ms used for drx-ShortCycle. For example, where n=[(SFN×10)+subframe number], where SFN is the system frame number, as defined in 3GPP technical specification (TS) 38.321, if

$$ceil ( n * \frac{drx - ShortCadence}{100} ) + 1 = ceil ( ( n + 1 ) * \frac{drx - ShortCadence}{100} ) ,$$

start the drx-onDurationTimer for this DRX group after drx-SlotOffset from the beginning of subframe n. For example, for drx-ShortCadence=120 Hz, subframe n=8, 16, 25, 33, 41, 50, . . . can satisfy the criteria. In this example, the device can jump of 1 subframe every 3 cycles to accommodate the one-third subframe part when duty cycle is 8.33 ms for 120 Hz. The resulting sequence can be the same as in the leap DRX cycle concept in the first example.

In a third example, the DRX configuration for configuring the DRX cycle can specify a value for a DRX cycle using a rational number of multimedia periodicity. For example, a new set of values can be added for drx-LongCycleStartOffset and/or drx-ShortCycle (e.g., as a new information element (IE) under a MAC-CellGroupConfig) that correspond to close approximates of the expected periods of transmission burst (e.g., 8.33 ms, 11.11 ms, 16.67 ms, etc.). In this example, a ceiling operation can be used to choose the previous subframe for the DRX cycle (or corresponding DRX ON duration). For example, if the Short DRX cycle is used for a DRX group, and ceil{[(SFN×10)+subframe number]modulo(drx-ShortCycle)}=ceil{(drx-StartOffset)modulo(drx-ShortCycle)}, start drx-onDurationTimer for this DRX group after drx-SlotOffset from the beginning of the subframe. For example, if the Long DRX cycle is used for a DRX group, and ceil{[(SFN×10)+subframe number]modulo(drx-LongCycle)}=drx-StartOffset, start drx-onDurationTimer for this DRX group after drx-SlotOffset from the beginning of the subframe. In another example, a floor operation can be used to choose the next subframe for the DRX ON cycle. For example, if the Short DRX cycle is used for a DRX group, and floor{[(SFN×10)+subframe number]modulo(drx-ShortCycle)}=floor{(drx-StartOffset)modulo(drx-ShortCycle)}, start drx-onDurationTimer for this DRX group after drx-SlotOffset from the beginning of the subframe. For example, if the Long DRX cycle is used for a DRX group, and floor{[(SFN×10)+subframe number]modulo(drx-LongCycle)}=drx-StartOffset, start drx-onDurationTimer for this DRX group after drx-SlotOffset from the beginning of the subframe.

In the above examples, a user equipment (UE) can receive the DRX configuration for implementing the DRX cycles to receive the transmission bursts. In some example, a network node (e.g., a base station/gNB) can transmit the DRX configuration to the UE, and the configuration can indicate the parameters descried above, whether including the parameters defined for DRX cycles in 5G NR and/or the extended parameters or values defined in the first, second, and third examples above.

In a fourth example, for the DRX configuration for configuring the DRX cycle, a command can be sent to shift the start offset for the DRX cycle. For example, a network node (e.g., base station/gNB) can transmit the command to the UE as a media access control (MAC) control element (CE) to shift the offset (e.g., drx-StartOffset parameter in the DRX configuration). For example, in 3GPP TS 38.321, the start of the ON duration of the DRX cycle can be, for a Short DRX cycle: [(SFN×10)+subframe number]modulo(drx-ShortCycle)=(drx-StartOffset)modulo(drx-ShortCycle), or for a Long DRX cycle: [(SFN×10)+subframe number]modulo(drx-LongCycle)=(drx-StartOffset). The network node can send the MAC CE to signal a change of the offset inside the period. When the network node detects that an offset can be changed to match better the arrival time of the next transmission burst (e.g., a data burst from an XR application), the network node can send a MAC CE (e.g., ‘Offset Change Command’) to signal the UE that the next offset shall be changed. For example, the network node can send the UE an offset value of the list, such as absolute value lists, where each list contains the absolute values of the offsets, or relative value lists, where each list contains the number of slots to shift the current offset. The UE can accordingly adjust the offset to align the DRX ON cycle with the transmission burst.

Aspects described herein relate to indicating support, or supported parameter values, for receiving transmission bursts in DRX mode. In some aspects, a UE can transmit UE assistance or capability information to a network node to indicate a support or preference for certain DRX parameters. For example, the UE assistance information can indicate support for, or preference of, one or more of the above examples for aligning DRX ON durations with transmission bursts, parameter values for supporting one or more of the above examples, and/or the like. In some aspects, network nodes can communicate UE context management messages that can indicate a support or preference for certain DRX parameters for a UE. For example, the UE context management messages, which may be communicated between a centralized unit (CU) of a base station/gNB and a distributed unit (DU) of a base station/gNB, can indicate support for, or preference of, one or more of the above examples for aligning DRX ON durations with transmission bursts, parameter values for supporting one or more of the above examples, and/or the like. Moreover, aspects are described herein in terms of DRX, and may be used for specific types of DRX, such as connected-mode DRX (CDRX). The terms are used interchangeably herein.

In an example, indicating support or preference for certain DRX modes or related parameters can allow a network to transmit transmission bursts and configure UEs or other devices to receive the transmission busts while also supporting DRX. Allowing the UEs or other devices to support DRX in this regard while still receiving transmission bursts can facilitate the UEs or other devices receiving significant amounts of data (e.g., for XR applications) while conserving power by terminating or reducing power to RF components during the DRX OFF durations. This can allow the UE or other device to have a more desirable power profile such to improve power consumption when operating using a battery, which can improve user experience when using the UE or other device.

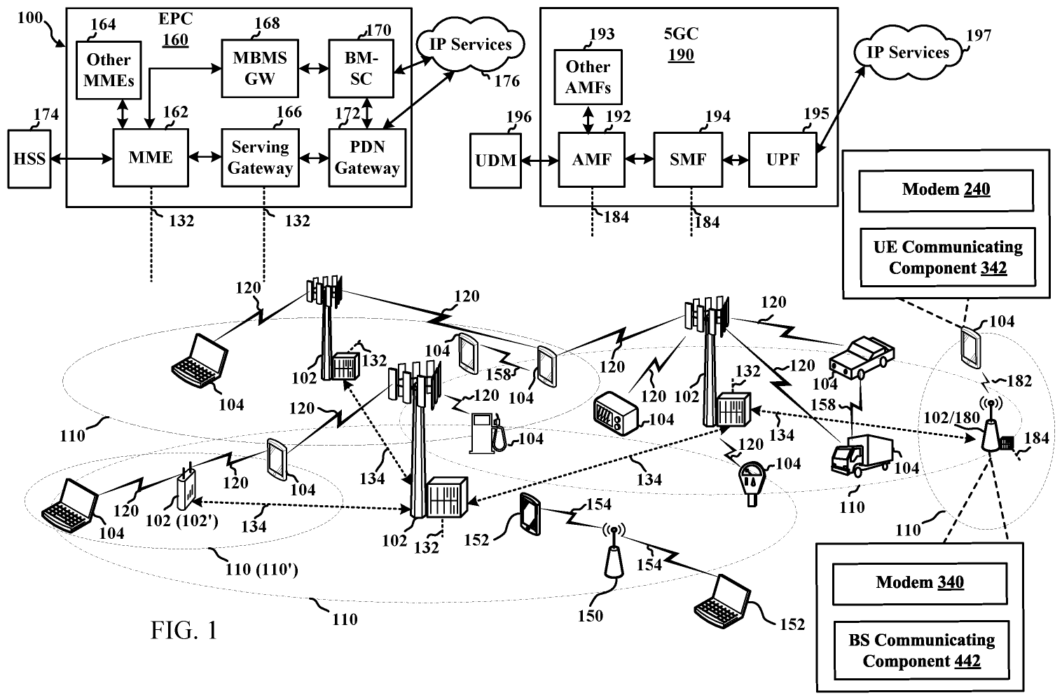

The described features will be presented in more detail below with reference to FIGS. 1-8.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDMTM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 240 and UE communicating component 342 for transmitting assistance information related to receiving transmission bursts in CDRX mode, in accordance with aspects described herein. In addition, some nodes may have a modem 340 and BS communicating component 442 for receiving assistance information for a device related to receiving transmission bursts in CDRX mode, in accordance with aspects described herein. Though a UE 104 is shown as having the modem 240 and UE communicating component 342 and a base station 102/gNB 180 is shown as having the modem 340 and BS communicating component 442, this is one illustrative example, and substantially any node or type of node may include a modem 240 and UE communicating component 342 and/or a modem 340 and BS communicating component 442 for providing corresponding functionalities described herein.

The base stations 102 configured for 4 G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, UE communicating component 342 can transmit assistance information related to the UE 104 receiving or processing transmission bursts when operating in CDRX mode. For example, UE communicating component 342 can transmit assistance information including one or more alignment parameters indicating a type of alignment supported or preferred to be perform in aligning CDRX durations for receiving transmission bursts, indicating values of parameters for performing a type of alignment, and/or the like. In an example, BS communicating component 442 can receive the assistance information and can configure one or more alignment parameters indicating a type of alignment for the UE 104 to perform, values of parameters for performing a type of alignment, and/or the like. For example, BS communicating component 442 can transmit the configuration of one or more alignment parameters to the UE 104, to one or more other network nodes (e.g., to a DU where BS communicating component 442 is configured in a CU, to a RU where BS communicating component 442 is configured in a DU, etc., as described further herein).

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (0 -RAN (such as the network configuration sponsored by the 0 -RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

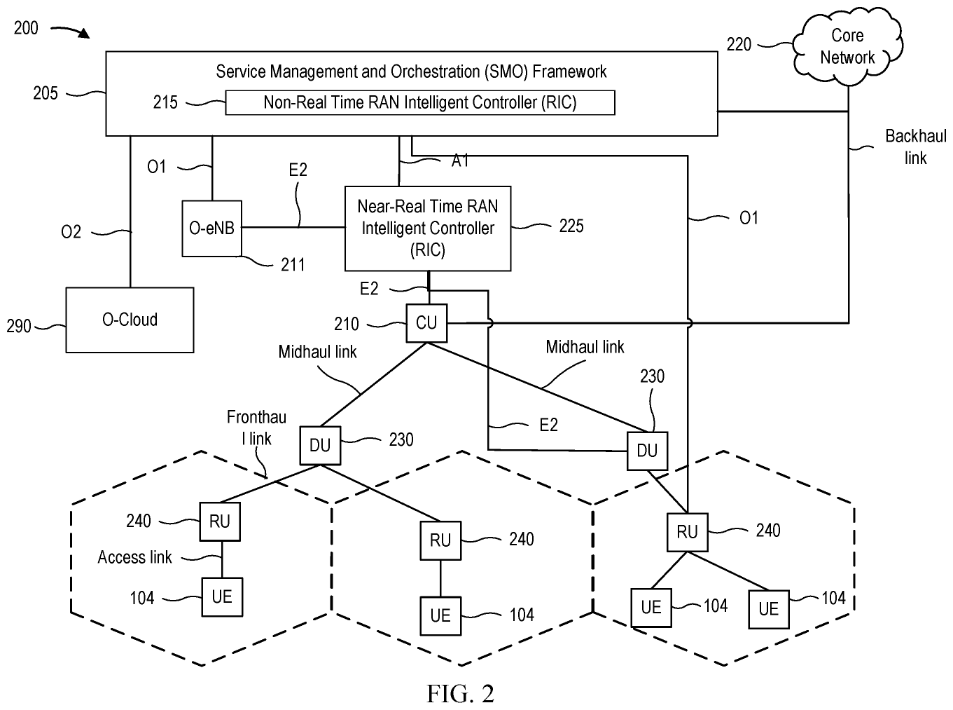

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (MC) 225 via an E2 link, or a Non-Real Time (Non-RT) MC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit — User Plane (CU-UP)), control plane functionality (i.e., Central Unit — Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an 0 -RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3 GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an 01 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an 02 interface). Such virtualized network elements can include, but are not limited to, CUs 210, DUs 230, RUs 240 and Near-RT RICs 225. In some implementations, the SMO Framework 205 can communicate with a hardware aspect of a 4 G RAN, such as an open eNB (0 -eNB) 211, via an 01 interface. Additionally, in some implementations, the SMO Framework 205 can communicate directly with one or more RUs 240 via an 01 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an AI interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT MC 225.

In some implementations, to generate AI/ML models to be deployed in the Near-RT MC 225, the Non-RT MC 215 may receive parameters or external enrichment information from external servers. Such information may be utilized by the Near-RT MC 225 and may be received at the SMO Framework 205 or the Non-RT MC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as AI policies).

In an example, BS communicating component 442, as described herein, can be at least partially implemented within a CU 210, and can transmit the one or more alignment parameters to one or more DUs 230. In this example, the one or more DUs 230 can configure the UE 104 with the alignment parameters for receiving the transmission burst in CDRX mode. In another example, BS communicating component 442, as described herein, can be at least partially implemented within a DU 230, and can transmit the one or more alignment parameters to one or more RUs 240. In this example, the one or more RUs 240 can configure the UE 104 with the alignment parameters for receiving the transmission burst in CDRX mode.

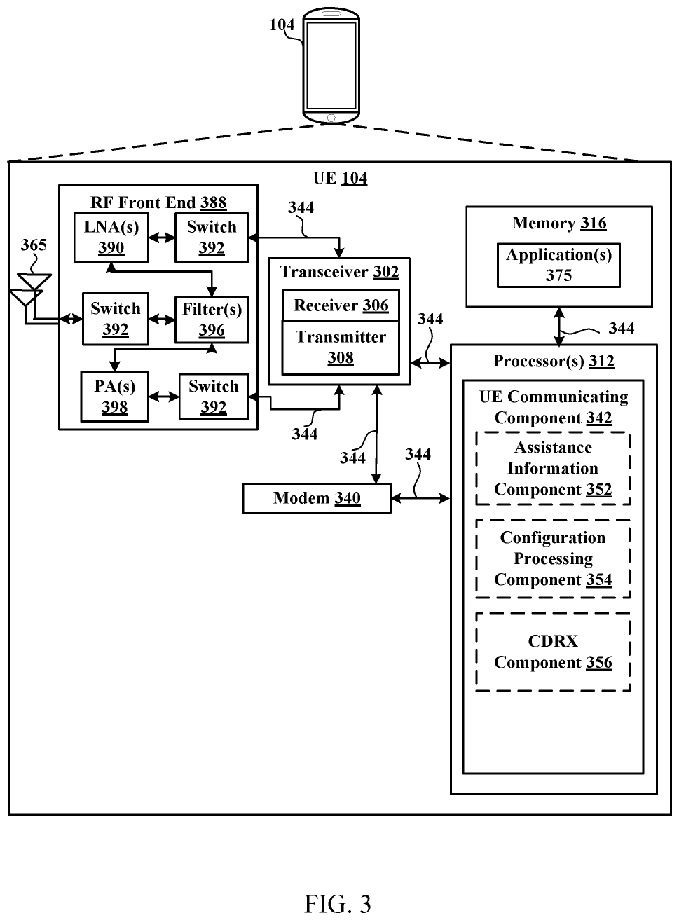

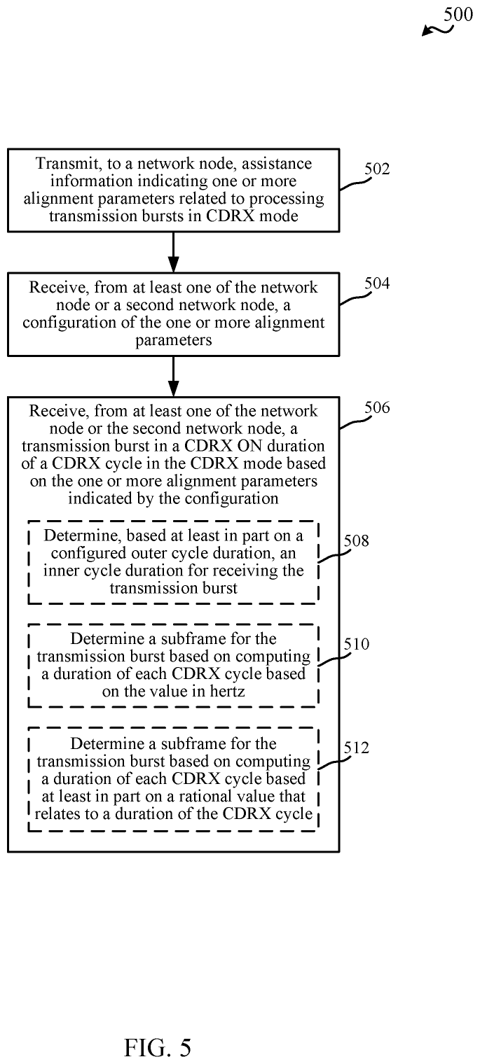

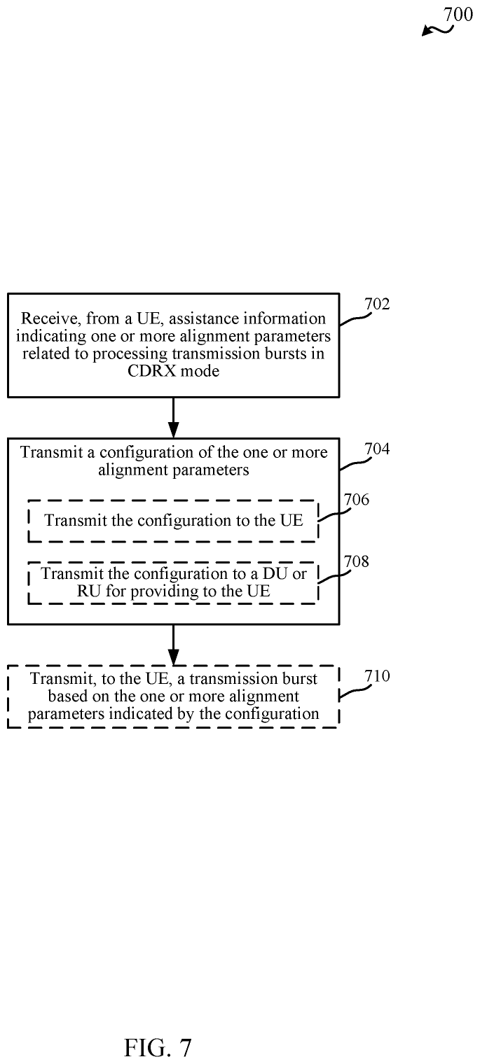

Turning now to FIGS. 3-8, aspects are depicted with reference to one or more components and one or more methods that may perform the actions or operations described herein, where aspects in dashed line may be optional. Although the operations described below in FIGS. 5 and 7 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and memory 316 and transceiver 302 in communication via one or more buses 344, which may operate in conjunction with modem 340 and/or UE communicating component 342 for modifying uplink transmission processes for CG resources to account for high RTT, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory 316 may be configured to store data used herein and/or local versions of applications 375 or UE communicating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), reference signal received power (RSRP), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include an assistance information component 352 for transmitting assistance information including one or more alignment parameters related to receiving transmission bursts in CDRX mode, a configuration processing component 354 for processing one or more alignment parameters received based on transmitting the assistance information, and/or a CDRX component 356 for operation in CDRX mode at the UE 104 and/or adjusting the CDRX mode based on the one or more alignment parameters to receive transmission bursts, in accordance with aspects described herein.

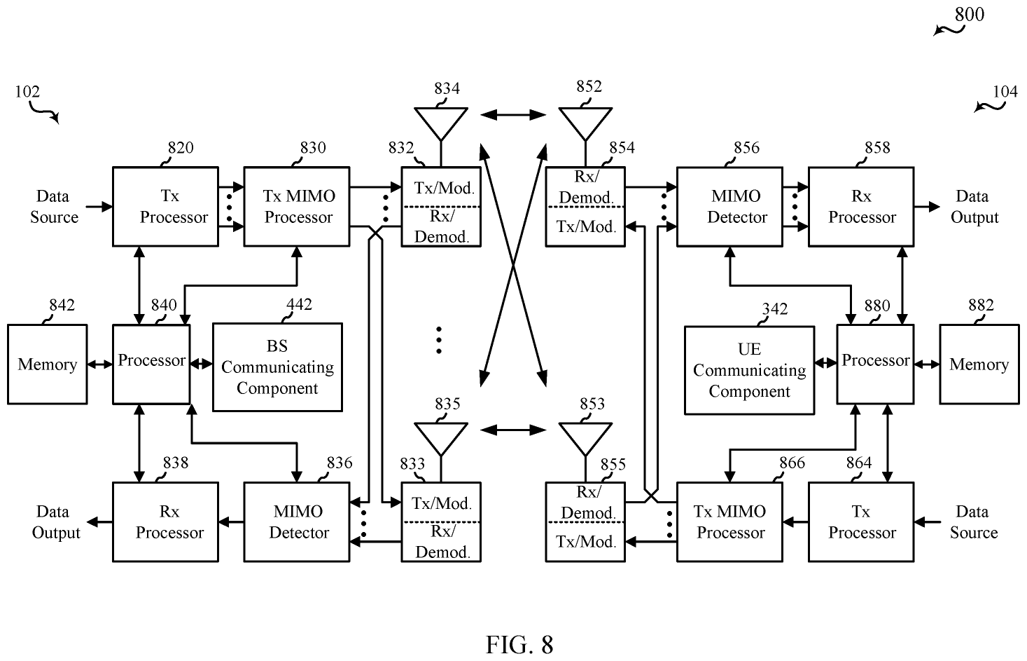

In an aspect, the processor(s) 312 may correspond to one or more of the processors described in connection with the UE in FIG. 8. Similarly, the memory 316 may correspond to the memory described in connection with the UE in FIG. 8.

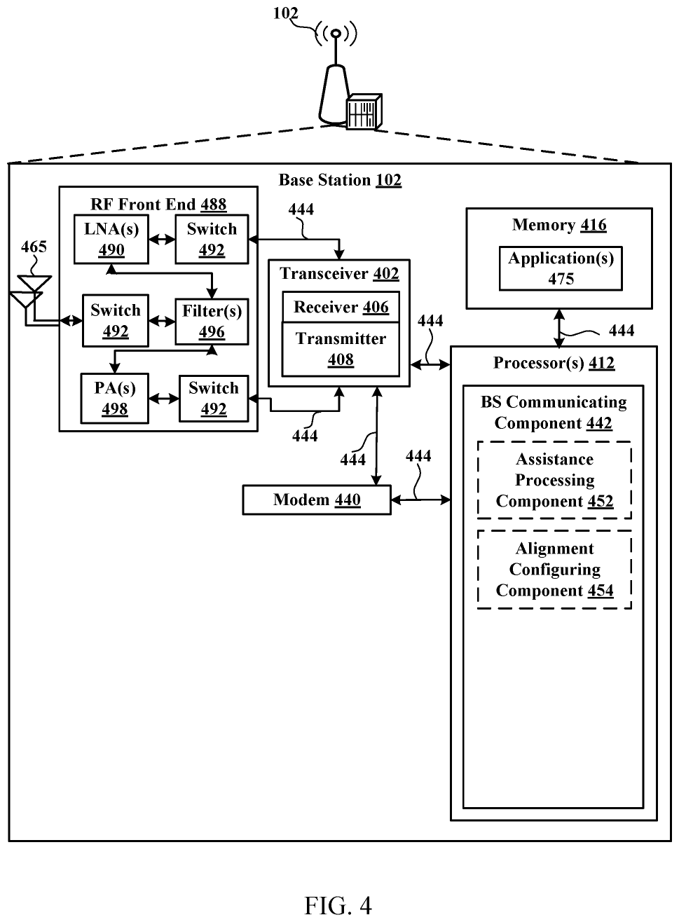

Referring to FIG. 4, one example of an implementation of base station 102 (e.g., a base station 102 and/or gNB 180, as described above) may include a variety of components, some of which have already been described above, but including components such as one or more processors 412 and memory 416 and transceiver 402 in communication via one or more buses 444, which may operate in conjunction with modem 440 and BS communicating component 442 for configuring devices for modifying uplink transmission processes for CG resources to account for high RTT, in accordance with aspects described herein.

The transceiver 402, receiver 406, transmitter 408, one or more processors 412, memory 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include an assistance processing component 452 for processing assistance information including one or more alignment parameters related to receiving transmission bursts in CDRX mode as received for a UE, and/or an alignment configuring component 454 for configuring one or more alignment parameters for the UE, in accordance with aspects described herein. In an example, one or more of the assistance processing component 452 or alignment configuring component 454 can be provided in a CU, DU, or RU in a disaggregated BS. In one example, a CU can include the assistance processing component 452 for processing the assistance information received from the UE. The CU can also include the alignment configuring component 454 for configuring the one or more alignment parameters for the UE. In this example, alignment configuring component 454 can transmit the one or more alignment parameters to the DU and/or RU for use in communicating with the UE at a lower (e.g., physical or MAC) layer. In one example, the DU and/or RU can also include an alignment configuring component 454 to configure the UE with the one or more alignment parameters.

In an aspect, the processor(s) 412 may correspond to one or more of the processors described in connection with the base station in FIG. 8. Similarly, the memory 416 may correspond to the memory described in connection with the base station in FIG. 8.

FIG. 5 illustrates a flow chart of an example of a method 500 for transmitting assistance information related to receiving transmission bursts in CDRX mode, in accordance with aspects described herein. In an example, a UE 104 can perform the functions described in method 400 using one or more of the components described in FIGS. 1 and 3.

In method 500, at Block 502, assistance information indicating one or more alignment parameters related to processing transmission bursts in CDRX mode can be transmitted to a network node. In an aspect, assistance information component 352, e.g., in conjunction with processor(s) 312, memory 316, transceiver 302, UE communicating component 342, etc., can transmit, to the network node (e.g., a base station 102, CU, DU, RU, of a disaggregated base station, etc.), assistance information indicating one or more alignment parameters related to processing transmission bursts in CDRX mode. For example, the assistance information can indicate one or more of a preferred or supported mechanism for aligning a CDRX cycle with expected arrival or receive time for a transmission burst from the network node (or another network node), one or more preferred or supported parameter values for implementing mechanism for aligning the CDRX cycle, and/or the like.

For the first example of the two-level DRX configuration, described above, assistance information component 352 can indicate, in the assistance information, a preference of, or support for, providing CDRX cycle alignment via the two-level DRX configuration. In an example, assistance information component 352 can also indicate at least one of the outer DRX cycle duration, or one or more inner DRX cycle durations.

For the second example of the DRX cycle formula and cadence parameter, described above, assistance information component 352 can indicate, in the assistance information, a preference of, or support for, providing CDRX cycle alignment via the DRX cycle formula and cadence parameter. In an example, assistance information component 352 can also indicate one or more preferred or supported cadences (e.g., in Hz instead of in ms). For example, assistance information component 352 can indicate preference or support of a cadence of 45 Hz, 60 Hz, 90 Hz, 120 Hz, etc. for the CDRX cycle.

For the third example of DRX cycle using rational number periodicity, described above, assistance information component 352 can indicate, in the assistance information, a preference of, or support for, providing CDRX cycle alignment via the DRX cycle using rational number periodicity. In an example, assistance information component 352 can also indicate one or more preferred or supported rational number periodicities. For example, assistance information component 352 can indicate preference or support of 8.33 ms, 11.11 ms, 16.67 ms, etc., for the CDRX cycle periodicity.

In 5G NR, for example, a UE can transmit UE assistance information (e.g., in RRC signaling) to the network to inform of preference for certain DRX parameters, which can be carried in a DRX-Preference-r16 information element (IE). The DRX-Preference-r16 IE can be defined to include a preferredDRX-InactivityTimer-r16 IE with possible enumerations indicating a number of durations in milliseconds for the inactivity timer in DRX (e.g., ms0, ms1, ms2, ms3, . . . ms2560), and the IE may have some spare values in the enumeration as well. The DRX-Preference-r16 IE can also be defined to include a preferredDRX-LongCycle-r16 IE with possible enumerations indicating a number of durations in milliseconds for the long cycle in DRX (e.g., ms10, ms20, ms32, ms40, . . . ms10240), and the IE may have some spare values in the enumeration as well. The DRX-Preference-r16 IE can also be defined to include a preferredDRX-ShortCycle-r16 IE with possible enumerations indicating a number of durations in milliseconds for the short cycle in DRX (e.g., ms2, ms3, ms4, ms5, . . . ms640), and the IE may have some spare values in the enumeration as well. The DRX-Preference-r16 IE can also be defined to include a preferredDRX-ShortCycleTimer-r16 IE with a possible integer value of 1 to 16.

For the first example of the two-level DRX configuration, described above, parameters of the DRX-Preference-r16 IE (or a similar IE defined for a subsequent release of 3 GPP) can be extended or modified to indicate the durations of the outer DRX cycle and/or one or more inner DRX cycles. For example, preferredDRX-Short-Cycle-r16 (and/or preferredDRX-LongCycle-r16) IEs can be extended or enhanced to carry the durations of the outer DRX cycle and/or one or more inner DRX cycles. In one example, in addition to the enumerations included for DRX-Preference-r16 IE, a sequence of two enumerates outerCycle and innerCycle can be added. In any case, assistance information component 352 can indicate, in the assistance information, at least one of the outer DRX cycle duration, or one or more inner DRX cycle durations to allow the network to configure the DRX cycle for receiving transmission bursts.

For the second example of the DRX cycle formula and cadence parameter, described above, parameters of the DRX-Preference-r16 IE (or a similar IE defined for a subsequent release of 3 GPP) can be extended or modified to indicate the cadence parameter values, in Hz, that are supported or preferred. For example, preferredDRX-Short-Cycle-r16 (and/or preferredDRX-LongCycle-r16) IEs can be extended or enhanced to carry the new values in Hz (e.g., 45, 6-, 90, 120 Hz). In one example, in addition to the enumerations included for DRX-Preference-r16 IE, a second enumeration for the cadence values can be added. In any case, assistance information component 352 can indicate, in the assistance information, the preferred or supported cadence(s) to allow the network to configure the DRX cycle for receiving transmission bursts.

For the third example of DRX cycle using rational number periodicity, described above, parameters of the DRX-Preference-r16 IE (or a similar IE defined for a subsequent release of 3 GPP) can be extended or modified to indicate the new rational values in milliseconds (e.g., 8.33, 11.11, 16.67 ms). In one example, in addition to the enumerations included for DRX-Preference-r16 IE, a second enumeration for the rational values for the DRX cycle duration can be added. In any case, assistance information component 352 can indicate, in the assistance information, the preferred or supported rational value(s) for the DRX cycle duration to allow the network to configure the DRX cycle for receiving transmission bursts.

In method 500, at Block 504, a configuration of the one or more alignment parameters can be received from at least one of the network node or a second network node. In an aspect, configuration processing component 354, e.g., in conjunction with processor(s) 312, memory 316, transceiver 302, UE communicating component 342, etc., can receive, from at least one of the network node or a second network node, the configuration of the one or more alignment parameters. For example, configuration processing component 354 can receive the configuration based on transmitting the assistance information (e.g., the configuration may include values for the alignment parameters that are indicated, in the assistance information, as preferred or supported). In an example, configuration processing component 354 can receive the configuration from the base station 102, from a CU, or from a DU or RU. In one example, for a disaggregated base station, assistance information component 352 can transmit the assistance information to a first network node, such as a RU or DU, and the first network node can transmit the assistance information to a CU. In this example, the CU can specify the configuration, and can transmit the configuration to the UE, which may be via the DU or RU. Thus, for example, configuration processing component 354 can receive the configuration from the CU, DU, or RU, in some examples.

For example, the one or more alignment parameters may indicate one or more of the type of alignment to use (e.g., the first example of the two-level DRX configuration, the second example of the DRX cycle formula and cadence parameter, the third example of DRX cycle using rational number periodicity, etc.). In another example, the one or more alignment parameters may additionally or alternatively indicate the corresponding parameter values configured for one or more of the types of alignment (e.g., outer and/or inner cycle duration, cadence, rational cycle duration, etc.). In an example, configuration processing component 354 can receive the configuration in RRC signaling from the base station 102. In another example, e.g., for the fourth example of shifting the offset, configuration processing component 354 can receive the configuration indicating the offset in a MAC CE.

In method 500, at Block 506, a transmission burst can be received, from at least one of the network node or the second network node, in a CDRX ON duration of a CDRX cycle in the CDRX mode based on the one or more alignment parameters indicated by the configuration. In an aspect, CDRX component 356, e.g., in conjunction with processor(s) 312, memory 316, transceiver 302, UE communicating component 342, etc., can configure the CDRX mode based on the one or more parameters, and/or the CDRX component 356 can receive, from at least one of the network node or the second network node, the transmission burst in the CDRX ON duration of the CDRX cycle in the CDRX mode based on the one or more alignment parameters indicated by the configuration. For example, CDRX component 356 can use the one or more alignment parameters for aligning or determining a subframe, slot, etc. for a CDRX ON duration of a CDRX cycle to receive the transmission burst.

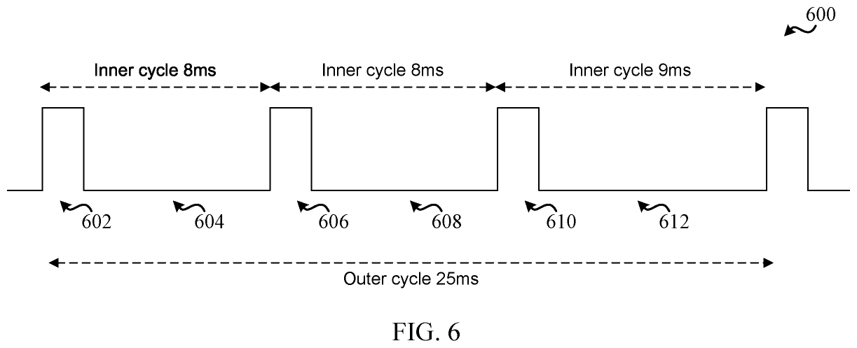

For the first example of the two-level DRX configuration, described above, CDRX component 356 can implement CDRX based on a CDRX cycle defined by the outer cycle duration and one or more inner cycle durations, which may be indicated by, or determined based on, one or more alignment parameter values indicated in the configuration. As example is shown in FIG. 6.

FIG. 6 illustrates an example of a timeline 600 for a CDRX mode. Timeline 600 includes three CDRX cycles, including a first CDRX cycle defined by CDRX ON duration 602 and CDRX OFF duration 604, a second CDRX cycle defined by CDRX ON duration 606 and CDRX OFF duration 608, and a third CDRX cycle defined by CDRX ON duration 610 and CDRX OFF duration 612. Timeline 600 can correspond to a 120 Hz transmission burst cadence, where each transmission burst is expected to arrive 8.33 ms apart. Accordingly, for example, an outer cycle duration of 25 ms can be used to receive according to the 8.33 ms cadence, where inner cycle durations of 8 ms, 8 ms, 9 ms can be specified. This can ensure the CDRX cycles align, or substantially align, to the transmission burst at least every three cycles (e.g., based on the additional lms of the 9 ms inner cycle extending to the start of the fourth transmission burst). In any case, for example, assistance information component 352 can indicate support or preference for the 25 ms outer cycle, the 8 ms, 8 ms, 9 ms configuration of inner cycles, etc., and configuration processing component 354 can receive the one or more alignment parameters indicating to use at least the 25 ms outer cycle, but also, in some examples, at least the 8 ms inner cycle. In one example, CDRX component 356 can determine to use the 8 ms inner cycle and can compute the difference in duration for the last inner cycle (the leap cycle) based on a remainder (e.g., based on the outer cycle duration module the inner cycle duration). In another example, the configuration received by configuration processing component 354 may specify the leap cycle duration as well.

In receiving the transmission burst at Block 506, optionally at Block 508, an inner cycle duration for receiving the transmission burst can be determined based at least in part on a configured outer cycle duration. In an aspect, CDRX component 356, e.g., in conjunction with processor(s) 312, memory 316, transceiver 302, UE communicating component 342, etc., can determine, based at least in part on the configured outer cycle duration, the inner cycle duration for receiving the transmission burst. For example, as described, the configuration may indicate the outer cycle duration, and CDRX component 356 can determine at least one inner cycle duration based on the outer cycle duration (e.g., where the at least one inner cycle duration is also not included in the configuration). For example, CDRX component 356 can determine the at least one inner cycle duration by adding a remainder of the outer cycle duration modulo the inner cycle duration to the last inner cycle.

In receiving the transmission burst at Block 506, optionally at Block 510, a subframe for the transmission burst can be determined based on computing a duration of each CDRX cycle based on the value in hertz. In an aspect, CDRX component 356, e.g., in conjunction with processor(s) 312, memory 316, transceiver 302, UE communicating component 342, etc., can determine the subframe for the transmission burst based on computing the duration of each CDRX cycle based on the value in hertz. As described for the second example of using the DRX cycle formula and configured cadence, where n=[(SFN×10)+subframe number], where SFN is the system frame number, as defined in 3 GPP technical specification (TS) 38.321, if

$$ceil ( n * \frac{drx - ShortCadence}{100} ) + 1 = ceil ( ( n + 1 ) * \frac{drx - ShortCadence}{100} ) ,$$

CDRX component 356 can start the drx-onDurationTimer for this DRX cycle after drx-SlotOffset from the beginning of subframe n, based on the drx-ShortCadence indicated in the configuration, to receive the transmission burst in the DRX ON duration. For example, CDRX component 356 can determine the subframes for the DRX ON duration for receiving for 120 Hz cadence as shown in FIG. 6 (e.g., as 8 ms, 8 ms and then 9 ms to accommodate the one third subframe part for duty cycle of 8.33 ms for 120 Hz).

In receiving the transmission burst at Block 506, optionally at Block 512, a subframe for the transmission burst can be determined based on computing a duration of each CDRX cycle based at least in part on a rational value that relates to a duration of the CDRX cycle. In an aspect, CDRX component 356, e.g., in conjunction with processor(s) 312, memory 316, transceiver 302, UE communicating component 342, etc., can determine the subframe for the transmission burst based on computing a duration of each CDRX cycle based at least in part on the rational value that relates to the duration of the CDRX cycle. As described for the third example, for a DRX cycle using a rational number periodicity, CDRX component 356 can determine the CDRX ON duration for receiving the transmission burst based on a ceiling or floor function for the Short DRX cycle or Long DRX cycle, where the cycle is configured as a rational value.

FIG. 7 illustrates a flow chart of an example of a method 700 for configuring a device for transmitting assistance information related to receiving transmission bursts in CDRX mode, in accordance with aspects described herein. In an example, a base station 102, or components of a disaggregated base station (e.g., one or more of a CU, DU, RU, etc.) can perform the functions described in method 700 using one or more of the components described in FIGS. 1 and 4.

In method 700, at Block 702, assistance information indicating one or more alignment parameters related to processing transmission bursts in CDRX mode can be received from a UE. In an aspect, assistance processing component 452, e.g., in conjunction with processor(s) 412, memory 416, transceiver 402, BS communicating component 442, etc., can receive, from the UE (e.g., UE 104), assistance information indicating one or more alignment parameters related to processing transmission bursts in CDRX mode. For example, assistance processing component 452 can receive the one or more alignment parameters from the UE 104 in RRC signaling, as described above, and the one or more alignment parameters may indicate types of alignment or corresponding parameter values that the UE 104 can support or prefers in performing alignment of CDRX ON durations of CDRX cycles to transmission bursts.

In method 700, at Block 704, a configuration of the one or more alignment parameters can be transmitted. In an aspect, alignment configuring component 454, e.g., in conjunction with processor(s) 412, memory 416, transceiver 402, BS communicating component 442, etc., can transmit the configuration of the one or more alignment parameters. For example, alignment configuring component 454 can select values for the one or more alignment parameters, which may include selecting a type of alignment (e.g., the first example, second example, third example, or fourth example described above), values for parameters for performing the type of alignment, and/or the like.

In transmitting the configuration at Block 704, optionally at Block 706, the configuration can be transmitted to the UE. In an aspect, alignment configuring component 454, e.g., in conjunction with processor(s) 412, memory 416, transceiver 402, BS communicating component 442, etc., can transmit the configuration to the UE 104. In this regard, the UE 104 can receive the configuration, as described above, and can operate the CDRX mode according to the parameters to receive the transmission bursts during the CDRX ON duration.

In transmitting the configuration at Block 704, optionally at Block 708, the configuration can be transmitted to a DU or RU for providing to the UE. In an aspect, alignment configuring component 454, e.g., in conjunction with processor(s) 412, memory 416, transceiver 402, BS communicating component 442, etc., can transmit the configuration to the DU or RU for providing to the UE. In an example, for a disaggregated base station, the CU can generate the configuration and can indicate the configured alignment parameters to the DU so that the DU can configure the UE 104. For example, the CU can transmit a UE context message, such as a F1-AP message labeled “UE Context Setup Request” to the DU to request setup of the UE context. The context can be modified by the CU sending the F1-AP message labeled “UE Context Modification Request” to the DU, which can include context information changes to the DU. These messages, which are defined in 3 GPP TS 38.473, can include DRX cycle information, in a DRX Cycle IE, which can specify the DRX parameters for the UE 104, such as Long DRX Cycle Length, Short DRX Cycle Length, and Short DRX Cycle Timer, which can have one of the enumerated values described above with respect to the DRX-Preference-r16 IE. These values can be extended, as described above, to support indication of the additional alignment parameters and values for aligning the CDRX mode for receiving transmission bursts.

For the first example of the two-level DRX configuration, described above, parameters of the DRX Cycle IE that can be indicated in the “UE Context Setup Request” or the “UE Context Modification Request” can be extended or modified to indicate the durations of the outer DRX cycle and/or one or more inner DRX cycles. For example, Short DRX Cycle Length (and/or Long DRX Cycle Length) IEs can be extended or enhanced to carry the durations of the outer DRX cycle and/or one or more inner DRX cycles. In one example, in addition to the enumerations included for DRX Cycle IE, a sequence of two enumerates outerCycle and innerCycle can be added. In any case, alignment configuring component 454 can configure, in the UE context message transmitted from CU to DU, at least one of the outer DRX cycle duration, or one or more inner DRX cycle durations to configure the DRX cycle for the UE for receiving transmission bursts.

For the second example of the DRX cycle formula and cadence parameter, described above, parameters of the DRX Cycle IE that can be indicated in the “UE Context Setup Request” or the “UE Context Modification Request” can be extended or modified to indicate the cadence parameter values, in Hz, that are supported or preferred. For example, Short DRX Cycle Length (and/or Long DRX Cycle Length) IEs can be extended or enhanced to carry the new values in Hz (e.g., 45, 6-, 90, 120 Hz). In one example, in addition to the enumerations included for DRX Cycle IE, a second enumeration for the cadence values can be added. In any case, alignment configuring component 454 can configure, in the UE context message transmitted from CU to DU, the preferred or supported cadence(s) to configure the DRX cycle for the UE for receiving transmission bursts.

For the third example of DRX cycle using rational number periodicity, described above, parameters of the DRX Cycle IE that can be indicated in the “UE Context Setup Request” or the “UE Context Modification Request” can be extended or modified to indicate the new rational values in milliseconds (e.g., 8.33, 11.11, 16.67 ms). In one example, in addition to the enumerations included for DRX Cycle IE, a second enumeration for the rational values for the DRX cycle duration can be added. In any case, alignment configuring component 454 can configure, in the UE context message transmitted from CU to DU, the preferred or supported rational value(s) to configure the DRX cycle for the UE for receiving transmission bursts.

In method 700, optionally at Block 710, a transmission burst can be transmitted, to the UE, based on the one or more alignment parameters indicated by the configuration. In an aspect, BS communicating component 442, e.g., in conjunction with processor(s) 412, memory 416, transceiver 402, etc., can transmit, to the UE (e.g., UE 104), the transmission burst based on the one or more alignment parameters indicated by the configuration. For example, BS communicating component 442 can transmit the transmission burst according to the cadence, based on which alignment configuring component 454 can have configured the CDRX parameters for the UE 104.

FIG. 8 is a block diagram of a MIMO communication system 800 including a base station 102 and a UE 104. The MIMO communication system 800 may illustrate aspects of the wireless communication access network 100 described with reference to FIG. 1. The base station 102 may be an example of aspects of the base station 102 described with reference to FIG. 1. The base station 102 may be equipped with antennas 834 and 835, and the UE 104 may be equipped with antennas 852 and 853. In the MIMO communication system 800, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 820 may receive data from a data source. The transmit processor 820 may process the data. The transmit processor 820 may also generate control symbols or reference symbols. A transmit MIMO processor 830 may perform spatial processing (e.g., precoding) on data symbols, control symbols, or reference symbols, if applicable, and may provide output symbol streams to the transmit modulator/demodulators 832 and 833. Each modulator/demodulator 832 through 833 may process a respective output symbol stream (e.g., for OFDM, etc.) to obtain an output sample stream. Each modulator/demodulator 832 through 833 may further process (e.g., convert to analog, amplify, filter, and upconvert) the output sample stream to obtain a DL signal. In one example, DL signals from modulator/demodulators 832 and 833 may be transmitted via the antennas 834 and 835, respectively.

The UE 104 may be an example of aspects of the UEs 104 described with reference to FIGS. 1 and 3. At the UE 104, the UE antennas 852 and 853 may receive the DL signals from the base station 102 and may provide the received signals to the modulator/demodulators 854 and 855, respectively. Each modulator/demodulator 854 through 855 may condition (e.g., filter, amplify, downconvert, and digitize) a respective received signal to obtain input samples. Each modulator/demodulator 854 through 855 may further process the input samples (e.g., for OFDM, etc.) to obtain received symbols. A MIMO detector 856 may obtain received symbols from the modulator/demodulators 854 and 855, perform MIMO detection on the received symbols, if applicable, and provide detected symbols. A receive (Rx) processor 858 may process (e.g., demodulate, deinterleave, and decode) the detected symbols, providing decoded data for the UE 104 to a data output, and provide decoded control information to a processor 880, or memory 882.

The processor 880 may in some cases execute stored instructions to instantiate a UE communicating component 342 (see e.g., FIGS. 1 and 3).

On the uplink (UL), at the UE 104, a transmit processor 864 may receive and process data from a data source. The transmit processor 864 may also generate reference symbols for a reference signal. The symbols from the transmit processor 864 may be precoded by a transmit MIMO processor 866 if applicable, further processed by the modulator/demodulators 854 and 855 (e.g., for single carrier-FDMA, etc.), and be transmitted to the base station 102 in accordance with the communication parameters received from the base station 102. At the base station 102, the UL signals from the UE 104 may be received by the antennas 834 and 835, processed by the modulator/demodulators 832 and 833, detected by a MIMO detector 836 if applicable, and further processed by a receive processor 838. The receive processor 838 may provide decoded data to a data output and to the processor 840 or memory 842.

The processor 840 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 800. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 800.

The following aspects are illustrative only and aspects thereof may be combined with aspects of other embodiments or teaching described herein, without limitation.

Aspect 1 is a method for wireless communication including transmitting, to a network node, assistance information indicating one or more alignment parameters related to processing transmission bursts in a DRX mode, receiving, from at least one of the network node or a second network node, a configuration of the one or more alignment parameters, and receiving, from at least one of the network node or the second network node, a transmission burst in a DRX ON duration of a DRX cycle in the DRX mode based on the one or more alignment parameters indicated by the configuration.

In Aspect 2, the method of Aspect 1 includes where the one or more alignment parameters relate to aligning arrival transmission bursts with DRX ON durations of DRX cycles in the DRX mode.

In Aspect 3, the method of any of Aspects 1 or 2 includes where the one or more alignment parameters include an outer cycle duration of an outer cycle that is supported for the DRX mode, and one or more inner cycle durations of one or more inner cycles within the outer cycle that are supported for the DRX mode.

In Aspect 4, the method of Aspect 3 includes where the one or more inner cycle durations include multiple inner cycle durations of different values.

In Aspect 5, the method of any of Aspects 1 to 4 includes where the one or more alignment parameters include a value in hertz that relates to a DRX cycle duration of the DRX mode, and where receiving the transmission burst in the DRX ON duration of the DRX cycle includes determining a subframe for the transmission burst based on computing a duration of each DRX cycle based on the value in hertz.

In Aspect 6, the method of Aspect 5 includes where computing the duration of each DRX cycle includes computing a number of milliseconds for a duty cycle based on the value in hertz and dividing by a number of subframes for the transmission burst.

In Aspect 7, the method of any of Aspects 1 to 6 includes where the one or more alignment parameters include a rational value that relates to a duration of the DRX cycle, and where receiving the transmission burst in the DRX ON duration of the DRX cycle is based on the rational value.

In Aspect 8, the method of Aspect 7 includes where receiving the transmission burst includes determining a subframe for the transmission burst based on the duration of the DRX cycle.

In Aspect 9, the method of Aspect 8 includes where determining the subframe is based on applying one of a ceiling operation or a floor operation to the duration of the DRX cycle for the transmission burst.

Aspect 10 is a method for wireless communication including receiving, from a UE, assistance information indicating one or more alignment parameters related to processing transmission bursts in a DRX mode, and transmitting a configuration of the one or more alignment parameters.

In Aspect 11, the method of Aspect 10 includes where the one or more alignment parameters relate to aligning arrival transmission bursts, at the UE, with DRX ON durations of DRX cycles in the DRX mode.

In Aspect 12, the method of any of Aspects 10 or 11 includes where transmitting the configuration includes transmitting, to a DU, the configuration for providing to the UE.

In Aspect 13, the method of any of Aspects 10 to 12 includes where transmitting the configuration includes transmitting, to the UE, the configuration.

In Aspect 14, the method of any of Aspects 10 to 13 includes transmitting, to the UE, a transmission burst based on the one or more alignment parameters indicated by the configuration.

In Aspect 15, the method of any of Aspect 10 to 14 includes where the one or more alignment parameters include an outer cycle duration of an outer cycle that is supported for the DRX mode, and one or more inner cycle durations of one or more inner cycles within the outer cycle that are supported for the DRX mode.

In Aspect 16, the method of Aspect 15 includes where the one or more inner cycle durations include multiple inner cycle durations of different values.

In Aspect 17, the method of any of Aspects 10 to 16 includes where the one or more alignment parameters include a value in hertz that relates to a duration of a DRX cycle.

In Aspect 18, the method of any of Aspects 10 to 17 includes where the one or more alignment parameters include a rational value that relates to a duration of a DRX cycle.

Aspect 19 is an apparatus for wireless communication including a transceiver, a memory configured to store instructions, and one or more processors communicatively coupled with the memory and the transceiver, where the one or more processors are configured to execute the instructions to cause the apparatus to perform any of the methods of Aspects 1 to 18.

Aspect 20 is an apparatus for wireless communication including means for performing any of the methods of Aspects 1 to 18.

Aspect 21 is a computer-readable medium including code executable by one or more processors for wireless communications, the code including code for performing any of the methods of Aspects 1 to 18.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
a memory configured to store instructions; and
one or more processors communicatively coupled with the transceiver and the memory, wherein the one or more processors are configured to:
transmit, to a network node, assistance information indicating one or more alignment parameters related to processing transmission bursts in a discontinuous receive (DRX) mode;
receive, from at least one of the network node or a second network node, a configuration of the one or more alignment parameters; and
receive, from at least one of the network node or the second network node, a transmission burst in a DRX ON duration of a DRX cycle in the DRX mode based on the one or more alignment parameters indicated by the configuration.

2. The apparatus of claim 1, wherein the one or more alignment parameters relate to aligning arrival transmission bursts with DRX ON durations of DRX cycles in the DRX mode.

3. The apparatus of claim 1, wherein the one or more alignment parameters include an outer cycle duration of an outer cycle that is supported for the DRX mode, and one or more inner cycle durations of one or more inner cycles within the outer cycle that are supported for the DRX mode.

4. The apparatus of claim 3, wherein the one or more inner cycle durations include multiple inner cycle durations of different values.

5. The apparatus of claim 1, wherein the one or more alignment parameters include a value in hertz that relates to a DRX cycle duration of the DRX mode, and wherein the one or more processors are configured to receive the transmission burst in the DRX ON duration of the DRX cycle at least in part by determining a subframe for the transmission burst based on computing a duration of each DRX cycle based on the value in hertz.

6. The apparatus of claim 5, wherein the one or more processors are configured to compute the duration of each DRX cycle at least in part by computing a number of milliseconds for a duty cycle based on the value in hertz and dividing by a number of subframes for the transmission burst.

7. The apparatus of claim 1, wherein the one or more alignment parameters include a rational value that relates to a duration of the DRX cycle, and wherein the one or more processors are configured to receive the transmission burst in the DRX ON duration of the DRX cycle based on the rational value.

8. The apparatus of claim 7, wherein the one or more processors are configured to receive the transmission burst at least in part by determining a subframe for the transmission burst based on the duration of the DRX cycle.

9. The apparatus of claim 8, wherein the one or more processors are configured to determine the subframe based on applying one of a ceiling operation or a floor operation to the duration of the DRX cycle for the transmission burst.

10. An apparatus for wireless communication, comprising:
a transceiver;
a memory configured to store instructions; and
one or more processors communicatively coupled with the transceiver and the memory, wherein the one or more processors are configured to:
receive, from a user equipment (UE), assistance information indicating one or more alignment parameters related to processing transmission bursts in a discontinuous receive (DRX) mode; and
transmit a configuration of the one or more alignment parameters.

11. The apparatus of claim 10, wherein the one or more alignment parameters relate to aligning arrival transmission bursts, at the UE, with DRX ON durations of DRX cycles in the DRX mode.

12. The apparatus of claim 10, wherein the one or more processors are configured to transmit, to a distributed unit (DU), the configuration for providing to the UE.

13. The apparatus of claim 10, wherein the one or more processors are configured to transmit, to the UE, the configuration.

14. The apparatus of claim 10, wherein the one or more processors are further configured to transmit, to the UE, a transmission burst based on the one or more alignment parameters indicated by the configuration.

15. The apparatus of claim 10, wherein the one or more alignment parameters include an outer cycle duration of an outer cycle that is supported for the DRX mode, and one or more inner cycle durations of one or more inner cycles within the outer cycle that are supported for the DRX mode.

16. The apparatus of claim 15, wherein the one or more inner cycle durations include multiple inner cycle durations of different values.

17. The apparatus of claim 10, wherein the one or more alignment parameters include a value in hertz that relates to a duration of a DRX cycle.

18. The apparatus of claim 10, wherein the one or more alignment parameters include a rational value that relates to a duration of a DRX cycle.

19. A method for wireless communication, comprising:
transmitting, to a network node, assistance information indicating one or more alignment parameters related to processing transmission bursts in a discontinuous receive (DRX) mode;
receiving, from at least one of the network node or a second network node, a configuration of the one or more alignment parameters; and
receiving, from at least one of the network node or the second network node, a transmission burst in a DRX ON duration of a DRX cycle in the DRX mode based on the one or more alignment parameters indicated by the configuration.

20. The method of claim 19, wherein the one or more alignment parameters relate to aligning arrival transmission bursts with DRX ON durations of DRX cycles in the DRX mode.

21. The method of claim 19, wherein the one or more alignment parameters include an outer cycle duration of an outer cycle that is supported for the DRX mode, and one or more inner cycle durations of one or more inner cycles within the outer cycle that are supported for the DRX mode.

22. The method of claim 21, wherein the one or more inner cycle durations include multiple inner cycle durations of different values.

23. The method of claim 19, wherein the one or more alignment parameters include a value in hertz that relates to a DRX cycle duration of the DRX mode, and wherein receiving the transmission burst in the DRX ON duration of the DRX cycle includes determining a subframe for the transmission burst based on computing a duration of each DRX cycle based on the value in hertz.

24. The method of claim 23, wherein computing the duration of each DRX cycle includes computing a number of milliseconds for a duty cycle based on the value in hertz and dividing by a number of subframes for the transmission burst.

25. The method of claim 19, wherein the one or more alignment parameters include a rational value that relates to a duration of the DRX cycle, and wherein receiving the transmission burst in the DRX ON duration of the DRX cycle is based on the rational value.

26. The method of claim 25, wherein receiving the transmission burst includes determining a subframe for the transmission burst based on the duration of the DRX cycle.

27. The method of claim 26, wherein determining the subframe is based on applying one of a ceiling operation or a floor operation to the duration of the DRX cycle for the transmission burst.

28. A method for wireless communication, comprising:
receiving, from a user equipment (UE), assistance information indicating one or more alignment parameters related to processing transmission bursts in a discontinuous receive (DRX) mode; and
transmitting a configuration of the one or more alignment parameters.

29. The method of claim 28, wherein the one or more alignment parameters relate to aligning arrival transmission bursts, at the UE, with DRX ON durations of DRX cycles in the DRX mode.

30. The method of claim 28, wherein transmitting the configuration includes transmitting, to a distributed unit (DU), the configuration for providing to the UE, or transmitting, to the UE, the configuration.
